(19) United States
(12) Patent Application Publication
(10) Pub. No.: US 2015/0178068 A1
(43) Pub. Date: Jun. 25, 2015

(54) ELECTRIC PRODUCT AND METHOD FOR UPDATING FIRMWARE OF THE SAME

(71) Applicant: LG Electronics Inc., Seoul (KR)

(72) Inventors: Minuk KIM, Seoul (KR); Sunghun LEE, Seoul (KR); Donghoon YI, Seoul (KR)

(21) Appl. No.: 14/563,242

(22) Filed: Dec. 8, 2014

(30) Foreign Application Priority Data
Dec. 19, 2013 (KR) 10-2013-0159673

(51) Int. Cl. G06F 9/445

(52) U.S. Cl. CPC G06F 8/65

(57) ABSTRACT

An electric product to communicate with a terminal includes: a wireless communication unit equipped in the electric product; a firmware storage unit storing a firmware file for update received from the terminal; a firmware modulation and confirmation unit determining whether the firmware file for update received from the terminal is error free; and a firmware update execution unit executing an update of firmware received from the terminal, wherein while the electric product is registered to the terminal, the electric product receives the firmware file for update from the terminal.

### CROSS-REFERENCE TO RELATED APPLICATIONS

The present application claims priority under 35 U.S.C. 119 and 35 U.S.C. 365 to Korean Patent Application No. 10-2013-0159673 (filed on Dec. 19, 2013), which is hereby incorporated by reference in its entirety.

### BACKGROUND

The present disclosure relates to an electric product and a firmware update method thereof.

The electric product is driven by a control unit executing firmware stored in a memory to perform an existing function. Additionally, the firmware of the electric product may be updated to improve the performance or an additional function.

### SUMMARY

Embodiments provide an electric product and a firmware update method thereof.

In one embodiment, an electric product to communicate in the electric product; a firmware storage unit to store a firmware file for update received from the terminal; a firmware modulation and confirmation unit to determine whether the received firmware file for update received from the terminal is error free; and a firmware update execution unit to execute an update of firmware received from the terminal, wherein while the electric product is registered to the terminal, the electric product receives the firmware file for update from the terminal.

In another embodiment, an electric product to communicate with a terminal includes: a wireless communication unit equipped in the electric product and operating in a security AP mode or a registration AP mode; a registration button at one side of the electric product and to change from the security AP mode unit to the registration AP mode in order for a communication connection with the terminal; a firmware storage unit to store a firmware file for update received from the terminal; and a firmware update execution unit to execute an update of firmware received from the terminal.

In further another embodiment, a method of updating firmware of an electric product includes: connecting an electric product and a terminal through communication; receiving, by the electric product, a firmware file for update from the terminal; determining, by the electric product, whether the received firmware file for update is error free; and when the received firmware file for update is error free, executing an update of firmware by the electric product and when the received firmware file for update has error, transmitting a file transmission error message to the terminal, by the electric product.

In still further another embodiment, a method of updating firmware of an electric product includes: connecting an electric product and a terminal through communication; receiving, by the electric product, a version of firmware for update from the terminal; determining, by the electric product, whether an update is needed by comparing a version of the firmware for update and a current firmware version; if an update of firmware is needed, requesting, by the electric product, a transmission of a firmware file for update from the terminal; receiving, by the electric product, the firmware file for update from the terminal; and executing an update of the received firmware for update.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a configuration of a network according to an embodiment of the present invention.

FIG. 2 is a block diagram illustrating an electric product and a terminal configuring a network according to an embodiment of the present invention.

FIG. 3 is view illustrating an initial registration process of an electric product and a terminal according to an embodiment of the present invention.

FIG. 4 is a flowchart illustrating a method of updating the firmware of an electric product according to an embodiment of the present invention.

FIG. 5 is a block diagram illustrating an electric product and a terminal configuring a network according to another embodiment of the present invention.

FIG. 6 is a flowchart illustrating a method of updating the firmware of an electric product according to another embodiment of the present invention.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail

it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

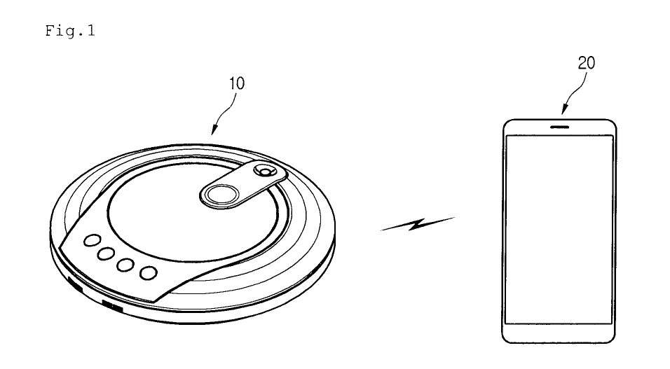

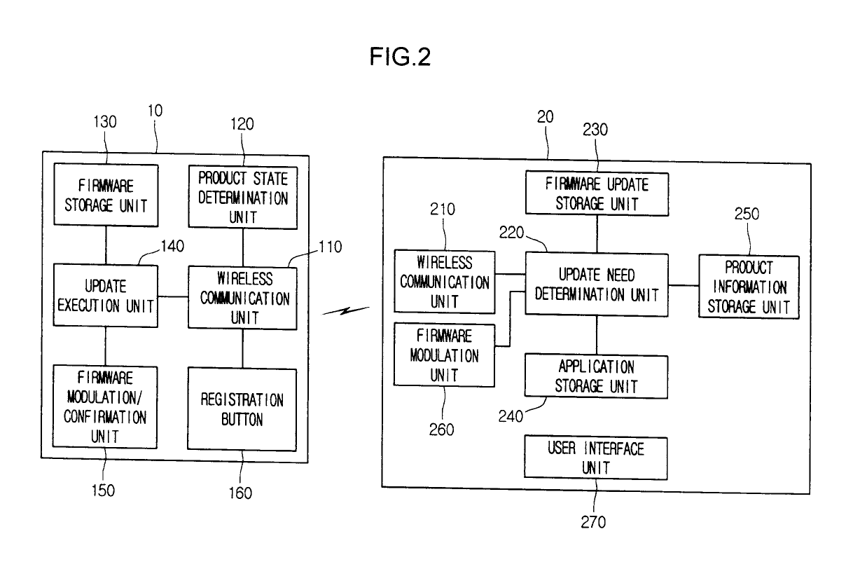

FIG. 1 is a view illustrating a configuration of a network according to an embodiment of the present invention. FIG. 2 is a block diagram of an electric product and a terminal configuring a network according to an embodiment of the present invention.

Referring to FIGS. 1 and 2, the network includes an electric product 10 and a terminal 20 directly communicating with the electric product 10.

The electric product 10 may be any product driven by firmware and in this embodiment, a robot cleaner cleaning the floor while moving automatically is described. However, it should not construed that the electric product is limited to robot cleaners.

The electric product 10 includes a wireless communication unit 110 as a Wi-Fi available communication module, a product state determination unit 120 determining a state of a product, a firmware storage unit 130 storing firmware, a firmware modulation and confirmation unit 150 modulating firmware received from the terminal 20 and confirming whether the firmware is error free, an update execution unit 140 executing the update of the firmware received from the terminal 20 and stored in the firmware storage unit 130, and a registration button 160 registering a product to the terminal 20. It should be noted that the units described may be hardware and/or a processor such as a microprocessor or electronic circuitry executing software/firmware.

The wireless communication unit 110 may operate in one of a security access point (AP) mode and a registration AP mode. That is, the wireless communication unit 110 may serve as a wireless router and accordingly, without using an additional wireless router, a direction communication between the electric product 10 and the terminal 20 may be possible.

The security AP mode is a mode with an encrypted first service set identifier (SSID).

On the other hand, the registration AP mode is a mode having non-encrypted second SSID information.

The registration button 160 may be located outside at one side of the electric product 10 and in order to register the electric product 10 with the terminal 20, a user may press the registration button 160 for a predetermined time.

Then, when the registration button 160 is pressed for a predetermined time, the wireless communication unit 110 switches from the security AP mode to the registration AP mode.

Although not shown in the drawing, the electric product 10 may further include a battery.

The product state determination unit 120 may determine whether the battery is charged and the charge amount of the battery.

Moreover, the terminal 20 may be a smartphone used as a portable terminal but is not limited thereto.

The terminal 20 may include a wireless communication unit 210 communicating with the wireless communication unit 110 via Wi-Fi, a firmware update storage unit 230 storing firmware update, an update need determination unit 220 determining whether the update of firmware is needed, an application storage unit 240 storing application, a product information storage unit 250 storing information for registration received from the electric product 10, a firmware modulation unit 260, and a user interface unit 270 It should be noted that the units described may be hardware and/or a processor such as a microprocessor or electronic circuitry executing software/firmware.

The terminal 20 may communicate with a web server managing the firmware update of the electric product 10 to receive firmware used therein and may then store the firmware in the firmware update storage unit 230.

Then, the update need determination unit 220 may determine whether the firmware update of the electric product 10 is necessary and whether the firmware update is available.

The application storage unit 240 stores an application for connecting to the electric product 10 and accessing with the second SSID information.

In this embodiment, the application storage unit 240, the firmware update storage unit 230, and the product information storage unit 250 may be separate storage units or one storage unit separated by function.

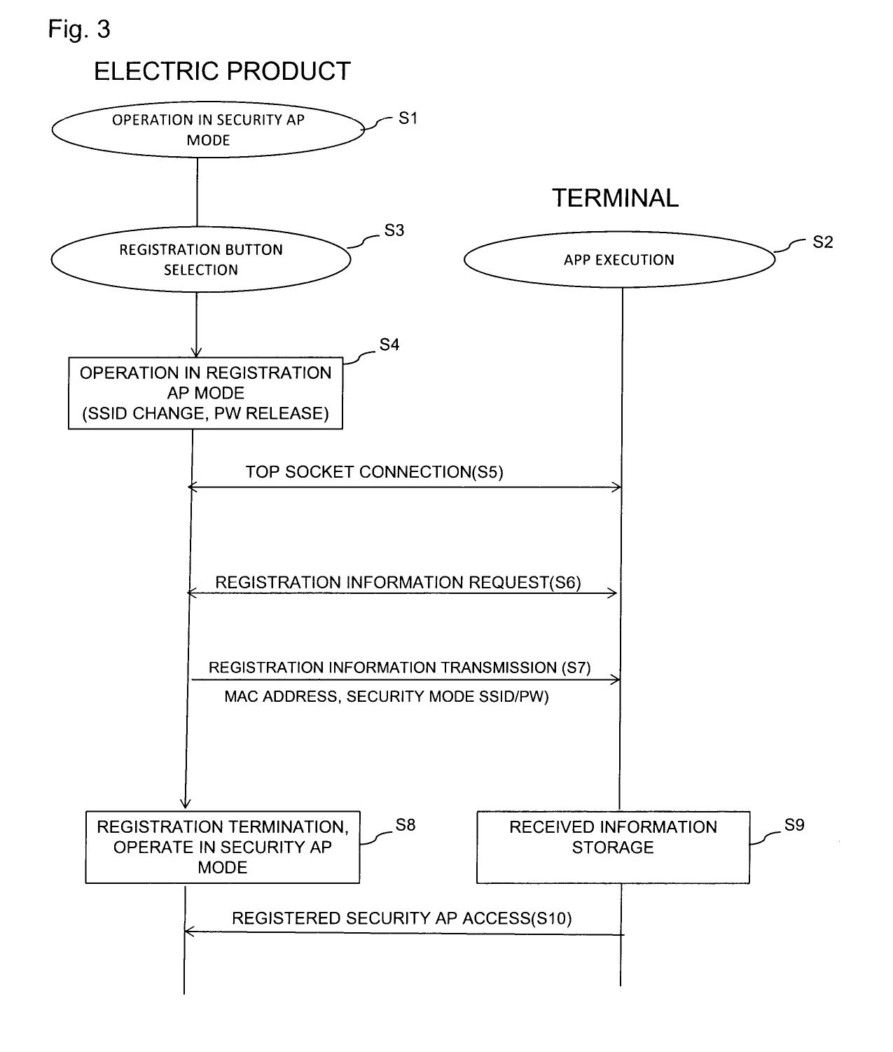

FIG. 3 is view illustrating an initial registration process of an electric product and a terminal according to an embodiment of the present invention.

Referring to FIG. 3, until the registration button 160 of the electric product 10 is selected, the wireless communication unit 110 operates in a security AP mode in operation S1. Then, an application is executed in the terminal through the user interface unit 270 in operation S2.

For the registration of the electric product 10, the registration button 160 of the electric product 10 may be pressed for a predetermined time in operation S3. That is, by selecting the registration button 160, a registration command is inputted.

Ones the registration command is inputted, the wireless communication unit 110 switches from the security AP mode to the registration AP mode in operation S4. That is, the first SSID of the wireless communication unit is switched to the second SSID and its password is released.

Since the terminal 20 knows the information on the second SSID already, and the wireless communication unit 210 of the terminal 20 makes an access with the second SSID of the wireless communication unit 110 of the electric product 10 in operation S5.

Then, the terminal 20 requests information for registration to the electric product 10 in operation S6. Then, the electric product 10 transmits information for registration to the terminal 20 in operation S7.

At this point, the information for registration may include product specific information (product serial number), media access control (MAC) address, first SSID, and the password of the first SSID.

After the electric product 10 transmits the information for registration to the terminal 20, the wireless communication unit 110 of the electric product 10 switches from the registration AP mode back to the security AP mode in operation S8.

Then, the terminal 20 stores the received information for registration in the product information storage unit 250 in operation S9.

Then, the electric product 10 is registered to the terminal 20 and while the wireless communication unit 110 of the electric product 10 operates in the security AP mode, the terminal 20 may access the first SSID of the wireless communication unit 110 by using the first SSID and the password stored in the product information storage unit 250.

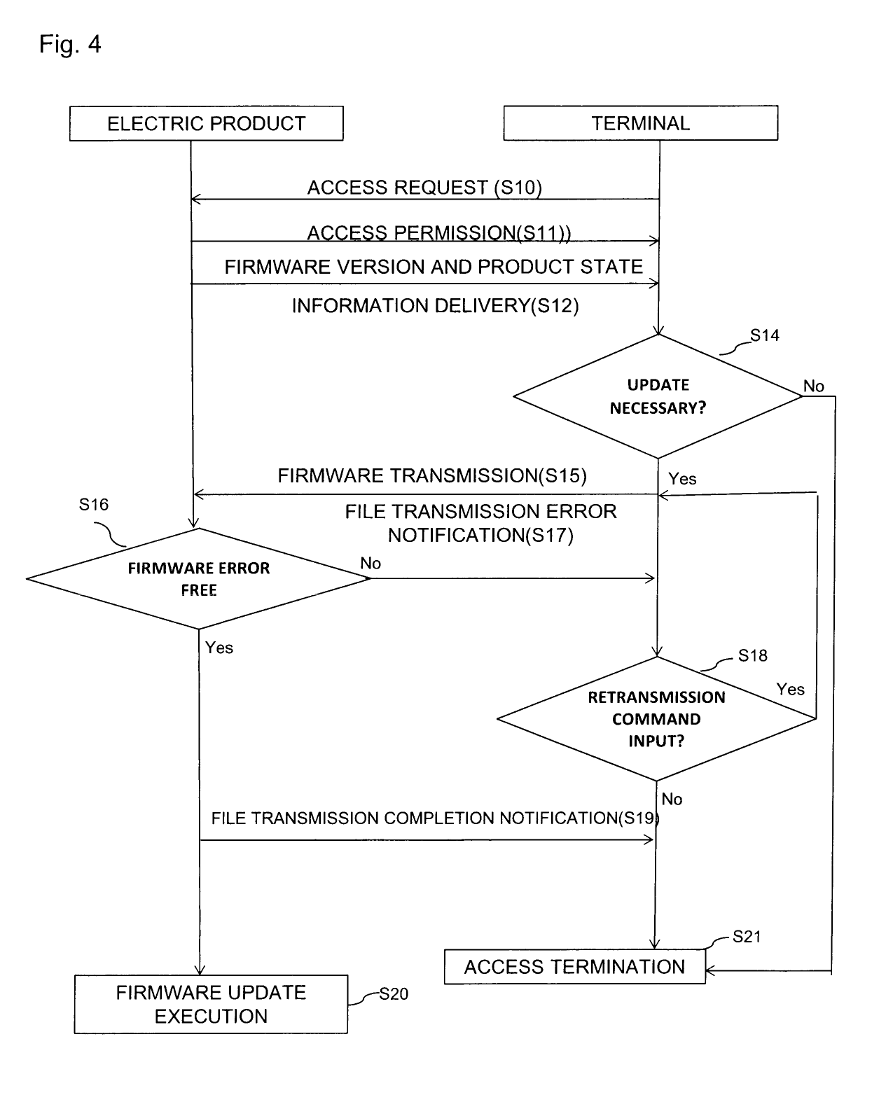

FIG. 4 is a flowchart illustrating a method of updating the firmware of an electric product according to an embodiment of the present invention.

Referring to FIGS. 3 and 4, by executing an application of the terminal 20, the terminal 20 requests an access to the electric product 10 in operation S10. As mentioned above, while the wireless communication unit 110 of the electric product 10 operates in the security AP mode, the terminal 20 may access the wireless communication unit 110 by using the first SSID and the password stored in the product information storage unit 250.

Then, the electric product 10 permits an access of the terminal 20 in operation S11.

Then, the electric product 10 transmits the current firmware version stored in the firmware storage unit 130 and the current state information on the electric product 10 determined by the product state determination unit 120 to the terminal 20 in operation S12.

The update need determination unit 220 of the terminal 20 determines whether an firmware update of the electric product 10 is necessary and whether the update is available at this point on the basis of the received firmware version and state information of the electric product 10 in operation S14.

When the firmware update of the electric product 10 is necessary, this means that the firmware version stored in the firmware update storage unit 230 of the terminal 20 is newer than the firmware version received from the electric product 10.

The firmware update may be performed in the electric product 10, for example, when the electric product 10 is not in operation and the amount of charge in the battery is greater than a reference amount while the battery is being charged. In this embodiment, the reference amount may be 50% but is not limited thereto.

Or, while the battery of the electric product 10 is not being charged, if the amount of charge in the battery is greater than a reference amount, firmware update may be performed.

In the case that the electric product 10 is a product driven at all times, for example, a refrigerator or a water purifier, when the firmware update of the electric product 10 is available, this means that power is being supplied to the electric product 10.

Additionally, in the case that the electric product 10 is a product driven intermittently, for example, a washing machine or a dishwasher, when the firmware update of the electric product 10 is available, the electric product 10 may not be in operation.

When the update need determination unit 220 determines that the firmware update of the electric product 10 is necessary and update is available at this point, the user interface unit 270 of the terminal 20 may display a screen for receiving a command for executing the update.

A user may input an update execution command on a screen displayed on the user interface unit 270. In this case, the terminal 20 transmits a firmware update file to the electric product 10 in operation S15.

As another example, without receiving a command for update execution from the user interface unit 270, the terminal 20 may automatically transmit a firmware update file to the electric product 10.

At this point, the firmware modulation unit 260 of the terminal 20 generates an encryption file by using an MD5 algorithm from the firmware update file. Then, the terminal 20 transmits the firmware update file and the encryption file to the electric product 10.

The electric product 10 stores the received firmware file and encryption file in the firmware storage unit 130 and determines whether the received firmware file is error free in operation S16.

The firmware modulation and confirmation unit 150 of the electric product 10 generates an encryption file by using the received firmware update file through the MD5 algorithm and determines whether the received encryption file is identical to the generated encryption file.

Then, when the received encryption file is identical to the generated encryption, the firmware modulation and confirmation unit 150 determines that the firmware update file received from the terminal 20 is error free.

When the firmware update file received from the terminal 20 is error free, the electric product 10 transmits a file transmission completion message to the terminal in operation S19. Then, the terminal 20 terminates the communication connection with the electric product 21 in operation S21.

Then, the update execution unit 140 of the electric product 10 executes the firmware update in operation S20.

On the other hand, when the received encryption file is not identical to the generated encryption file, the electric product 10 transmits a file transmission error message to the terminal in operation S17. Then, the firmware update file stored in the firmware storage unit 130 is deleted.

When the terminal 20 receives the file transmission error message, the user interface unit 270 may display a screen for file retransmission command input. A user inputs a file retransmission command on a screen of the user interface unit 270 in operation S18 and the terminal 20 retransmits a firmware update file to the electric product 10. Or, the terminal 20 may retransmit the firmware update file automatically without receiving a file retransmission command.

According to the embodiment of the present invention, even when an additional wireless router is not installed in a place including an electric product, since a wireless communication unit of the electric product serves as a wireless router, a terminal and the electric product communicate directly with each other. Therefore, the cost to purchase a wireless router may be reduced.

Additionally, by executing an application of the terminal and pressing a registration button equipped at the electric product, the electric product is registered to the terminal, so that a registration process of the electric product becomes simple and user's convenience is improved.

Additionally, since the electric product receiving a firmware update file determines whether the file is error free, although a firmware update file is received, firmware update is not performed due to a corrupt file.

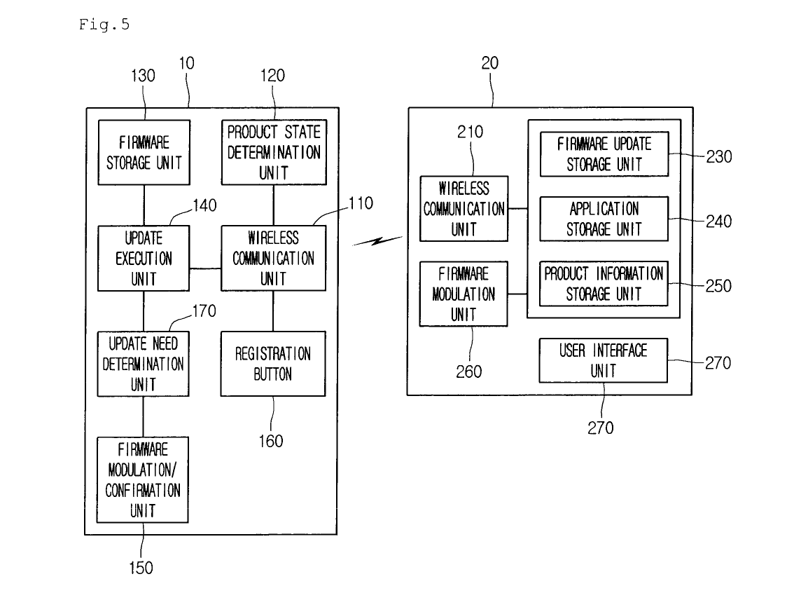

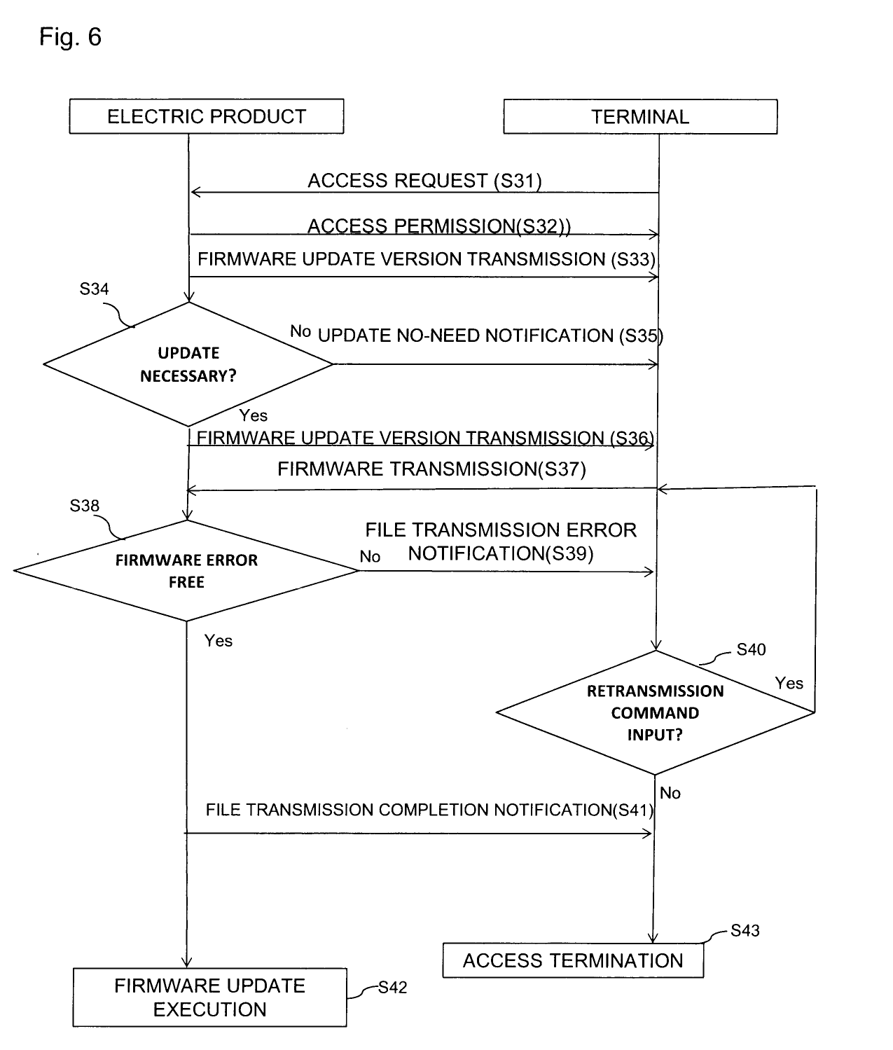

FIG. 5 is a block diagram of an electric product and a terminal configuring a network according to another embodiment of the present invention. FIG. 6 is a flowchart illustrating a firmware update method of an electric product according to another embodiment of the present invention.

Referring to FIG. 5, the electric product 10 may further include an update need determination unit 170 in addition to a wireless communication unit 110, a product state determination unit 120, a firmware storage unit 130, an update execution unit 140, a firmware modulation and confirmation unit 150, and a registration button 160. That is, unlike a previous embodiment, the terminal 20 may not determine whether firmware update is necessary and available but the electric product 10 may determine whether firmware update is necessary and available.

Referring to FIG. 6, by executing an application of the terminal 20, the terminal 20 requests an access to the electric product 10 in operation S31. As mentioned above, while the wireless communication unit 110 of the electric product 10 operates in the security AP mode, the terminal 20 may access the wireless communication unit 110 by using the first SSID and the password stored in the product information storage unit 250.

Then, the electric product 10 permits an access of the terminal 20 in operation S32.

Then, the terminal 20 transmits the firmware update version stored in the firmware update storage unit 230 to the electric product 10 in operation S33.

The update need determination unit 220 of the electric product 10 determines whether the firmware update is necessary and available at this point on the basis of the received firmware update version and state information determined by the product state determination unit 120 in operation S34. Since a method of determining whether update is necessary and available is identical to the above method in the previous embodiment, its detailed description is omitted.

When the update need determination unit 170 determines that the firmware update is unnecessary at this point, the electric product 10 transmits an update no need message to the terminal 20 in operation S35.

On the other hand, when the update need determination unit 170 determines that the firmware update is available at this point, the electric product 10 requests a firmware update transmission from the terminal 20 in operation S36. Then, the terminal 20 transmits a firmware update file to the electric product 10 in operation S37.

At this point, the firmware modulation unit 260 of the terminal 20 generates an encryption file by using the MD5 algorithm from the firmware update file. Then, the terminal 20 transmits the firmware update file and the encryption file to the electric product 10.

The electric product 10 stores the received firmware file and encryption file in the firmware storage unit 130 and determines whether the received firmware file is error free in operation S38.

The firmware modulation and confirmation unit 150 of the electric product 10 generates an encryption file by using the received firmware update file through the MD5 algorithm and determines whether the received encryption file is identical to the generated encryption file. Then, when the received encryption file is identical to the generated encryption, the firmware modulation and confirmation unit 150 determines that the firmware update file received from the terminal 10 is error free.

When the firmware update file received from the terminal 20 has error, the electric product 10 transmits a file transmission completion message to the terminal in operation S41. Then, the terminal 20 terminates the communication connection with the electric product 21 in operation S43.

Then, the update execution unit 140 of the electric product 10 executes the firmware update in operation S42.

On the other hand, when the received encryption file is not identical to the generated encryption file, the electric product 10 transmits a file transmission error message to the terminal in operation S39. Then, the firmware update file stored in the firmware storage unit 130 is deleted.

When the terminal 20 receives the file transmission error message, the user interface unit 270 may display a screen for file retransmission command input. A user inputs a file retransmission command on a screen of the user interface unit 270 in operation S40 and the terminal 20 retransmits a firmware update file to the electric product 10. Or, the terminal 20 may retransmit the firmware update file automatically without receiving a file retransmission command.

In the above embodiments, it is described that by changing a mode of a wireless communication unit through a registration button equipped at an electric product, the registration of the electric product is performed. Unlike this, a near field communication (NFC) tag is equipped at the electric product and by tagging the terminal with the NFC tag, it is possible to perform the registration of the electric product.

That is, the NFC tag may store unique information on a product, MAC address, and the password of a first SSID, and when the terminal is tagged with the NFC tag, the electric product 10 may transmit information for registration stored in the NFC tag to the terminal. Then, the terminal receiving the information for registration may access with the first SSID of the electric product.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric product to communicate with a terminal, the electric product comprising:
a wireless communication unit equipped in the electric product;
a firmware storage unit to store a firmware file for update received from the terminal;
a firmware modulation and confirmation unit to determine whether the received firmware file for update received from the terminal is error free; and
a firmware update execution unit to execute an update of firmware received from the terminal,
wherein while the electric product is registered to the terminal, the electric product receives the firmware file for update from the terminal.

2. The electric product according to claim 1, wherein when the electric product is in communication with the terminal, the electric product receives the firmware file for update from the terminal; and the firmware modulation, and confirmation unit determines whether the received firmware file for update is error free.

3. The electric product according to claim 2, wherein when the firmware modulation and confirmation unit determines that the received firmware file for update is error free, the electric product transmits a file transmission completion message to the terminal and the firmware update execution unit executes firmware update.

4. The electric product according to claim 2, wherein when the firmware modulation and confirmation unit determines that the firmware file for update has error, the electric product deletes a firmware file for update stored in the firmware storage unit and transmits a file transmission error message to the terminal.

5. The electric product according to claim 2, wherein the electric product receives the firmware file for update and an encryption file generated from the firmware file for update from the terminal; and
the firmware modulation and confirmation unit generates an encryption file from the firmware file for update and compares the received encryption file and the encryption file generated by the firmware modulation and confirmation unit to determine whether the received firmware file for update is error free.

6. The electric product according to claim 1, wherein when the electric product is in communication with the terminal, the electric product transmits a current firmware version to the terminal and receives a firmware file for update having a newer version than the current firmware version from the terminal if the terminal determines that the newer version is available on the basis of the received current firmware version; and
the firmware modulation and confirmation unit determines whether the received firmware file for update is error free.

7. The electric product according to claim 6, wherein when the electronic product is in communication with the terminal, the electric product transmits a current operation state to the terminal; and
when the electric product is in not in an operation, the electric product receives the firmware file for update from the terminal.

8. The electric product according to claim 1, further comprising an update need determination unit to determine whether a firmware update of the electric product is needed,
wherein when the electric product is in communication with the terminal, the electric product receives a version of firmware for update from the terminal; and
the update need determination unit compares a version of the received firmware for update and a current firmware version stored in the firmware storage unit to determine whether an update is needed.

9. The electric product according to claim 8, further comprising a product state determination unit Lo determine current state information of the electric product, wherein the update need determination unit determines whether a firmware update is available on the basis of information determined by the product state determination unit.

10. The electric product according to claim 9, wherein when the electric product is not in an operation, the update need determination unit determines whether a firmware update is available.

11. The electric product according to claim 9, wherein when the update need determination unit determines that a firmware update is necessary and a firmware update is available, the electric product requests a transmission of firmware for update from the terminal.

12. The electric device according to claim 1, wherein the wireless communication unit operates in a security access point (AP) mode or a registration AP mode.

13. The electric product according to claim 12, further comprising a registration button at one side of the electric product to change from the security AP mode to the registration AP mode in order for the terminal to have access to the electric product.

14. The electric product according to claim 13, wherein when the wireless communication unit switches to the registration AP mode, the wireless communication unit is in communication with the terminal and transmits information for registration of the electric product to the terminal.

15. The electric product according to claim 14, wherein the information for registration comprises a serial number of the electric product, media access control (MAC) address, and a password of a first service set identifier (SSID).

16. An electric product to communicate with a terminal, the electric product comprising:
a wireless communication unit equipped in the electric product and operating in a security access point (AP) mode or a registration AP mode;
a registration button at one side of the electric product to change from the security AP mode to the registration AP mode in order for a communication connection with the terminal;
a firmware storage unit to store a firmware file for update received from the terminal; and
a firmware update execution unit to execute an update of firmware received from the terminal.

17. The electric product according to claim 16, further comprising a firmware modulation and confirmation unit to determine whether the firmware file for update received from the terminal is error free, wherein when the firmware modulation and confirmation unit determines that the firmware file for update is error free, the electric product transmits a file transmission completion message to the terminal and the firmware update execution unit executes firmware update.

18. The electric product according to claim 17, wherein when the firmware modulation and confirmation unit determines that the firmware file for update has error, the electric product deletes the firmware file for update stored in the firmware storage unit and transmits a file transmission error message to the terminal.

19. A method of updating firmware of an electric product, the method comprising:
connecting an electric product and a terminal through communication;
receiving, by the electric product, a firmware file for update from the terminal;
determining, by the electric product, whether the received firmware file for update is error free; and
when the received firmware file for update is error free, executing an update of firmware by the electric product and when the received firmware file for update has error, transmitting a file transmission error message to the terminal, by the electric product.

20. A method of updating firmware of an electric product, the method comprising:
connecting an electric product and a terminal through communication;
receiving, by the electric product, a version of firmware for update from the terminal;
determining, by the electric product, whether an update is needed by comparing a version of the firmware for update and a current firmware version of the electric product;
if an update of firmware is needed, requesting, by the electric product, a transmission of a firmware file for update from the terminal;
receiving, by the electric product, the firmware file for update from the terminal; and
executing an update of the received firmware for update.
